(19) United States
(12) Patent Application Publication
(10) Pub. No.: US 2006/0164210 A1
(43) Pub. Date: Jul. 27, 2006

(54) On-board wireless receiver having two antennas

(75) Inventor: Haruyuki Ikeo, Chiryu-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/326,372

(22) Filed: Jan. 6, 2006

(30) Foreign Application Priority Data
Jan. 26, 2005 (JP) 2005-18727

(51) Int. Cl. B60R 25/00

(52) U.S. Cl. 340/5.72; 343/711

(57) ABSTRACT

An on-board receiver device includes a receiver having two antennas and a controller for controlling operation of the receiver. A first input signal from a keyless entry system and a second input signal from a tire pressure monitoring system are wirelessly transmitted to the receiver. Two input signals have different frequencies from each other. One of the input signals is selected at a time and processed through the receiver to obtain a base band signal (data signal) included in the input signal. In this manner, two input signals can be handled in a single receiver device without causing confusion between two input signals.

### CROSS-REFERENCE TO RELATED APPLICATION

This application is based upon and claims benefit of priority of Japanese Patent Application No. 2005-18727 filed on Jan. 26, 2005, the content of which is incorporated herein by reference.

### BACKGROUND OF THE INVENTION

1. Field of the Invention

The present invention relates to a wireless receiver mounted on an automotive vehicle, the receiver wirelessly receiving a signal for operating a keyless entry system and a signal from a tire pressure monitoring system.

2. Description of Related Art

A keyless entry system for an automotive vehicle, which includes an on-board receiver for receiving a wireless signal sent from a remote controller, has been known hitherto. In this system, a door-lock of the vehicle is locked or unlocked according to a signal sent from the remote controller. An example of the keyless entry system is disclosed in JP-A-2002-129794. A tire pressure monitoring system (referred to as TPMS) in which tire pressure in tires is automatically and wirelessly monitored is also known. An example of the TPMS is disclosed in JP-A-2001-250186.

An example of a conventional receiver 101 used in the keyless entry system will be briefly described with reference to FIG. 4. A wireless signal transmitted from a remote controller is received by an antenna 11. In this example, the wireless signal has a frequency of 315 MHz. The signal received by the antenna 11 is fed to a SAW (surface wave)-filter 13 to eliminate noises other than the signal having 315 MHz. A level of the signal is amplified by a amplifier 15, and fed to a mixer 17 to obtain an intermediate frequency signal. The mixer 17 mixes the received signal (315 MHz in this example) with a local frequency signal (304.3 MHz in this example) generated in an oscillator 19, thereby obtaining an intermediate frequency signal (10.7 MHz).

The intermediate frequency signal is fed to a band pass filter 21 that allows only the intermediate frequency signal to pass. Then, the intermediate frequency signal is fed to a demodulator 23 that detects a base band signal with which the signal inputted from the antenna 11 is modulated. The base band signal is fed to a low pass filter 25 that cuts off noises having a frequency higher than a cutoff frequency of the low pass filter 25. Then the base band signal is fed to a, waveform shaping circuit 27 that shapes up the waveform to obtain an output signal. The output signal is supplied to a control circuit (not shown), in which the output signal having a rectangular waveform is converted into a digital-signal consisting of bits “1” and “0”.

The receiver 101 shown in FIG. 4 is used as a receiver in the keyless entry system. The same receiver is applicable to the tire pressure monitoring system. However, if the wireless signals having the same frequency are used both in the keyless entry system and the tire pressure monitoring system, both wireless signals are not able to differentiate in the same receiver. Accordingly, it is conventionally required to use different frequencies in both systems and to receive the wireless signals by respectively different receivers. This makes the systems large in size and expensive in cost.

### SUMMARY OF THE INVENTION

The present invention has been made in view of the above-mentioned problem, and an object of the present invention is to provide an improved on-board receiver that is able to handle signals of both the keyless entry system and the tire pressure monitoring system.

The receiver device of the present invention is mounted on an automotive vehicle to handle two input signals having different frequencies. A first input signal may be a signal wirelessly sent from a remote controller of a door-lock system, and a second input signal may be a signal wirelessly sent from a tire pressure monitoring system mounted on the vehicle. The receiver device includes a receiver having a first antenna to receive the first input signal and a second antenna to receive the second input signal, and a controller for controlling operation of the receiver and actuators such as a door-lock motor.

The receiver further includes an amplifier for amplifying the input signals, a mixer for generating an intermediate frequency signal by mixing the input signal with a local frequency signal generated in an oscillator, a demodulator for abstracting a base band signal included in the input signal. Either the first input signal or the second input signal is selected by an input switch and fed to the amplifier. The first input signal is mixed with the first local frequency signal to obtain the intermediate frequency signal, while the second input signal is mixed with the second local frequency signal to obtain the same intermediate frequency signal. The intermediate frequency signal is fed to the demodulator that abstracts base band signals included in the input signals.

The controller brings the receiver device to either a first state or a second state. In the first state, the first input signal is selected, and the first input signal is mixed with the first local frequency signal to obtain the intermediate frequency signal. In the second state, the second input signal is selected, and the second input signal is mixed with the second local frequency signal to obtain the intermediate frequency signal.

In the case where signals from the keyless entry system and the tire pressure monitoring system are handled, the signal from the keyless entry system is selected as the input to be processed in the receiver device when an ignition switch of the vehicle is turned off, while the signal from the tire pressure monitoring system is selected as the input when the ignition switch is turned on. A low pass filter may be used to eliminate noises included in the base band signals. A cutoff frequency of the low pass filter may be selected to correspond to the first state or the second state. Either one of the antennas may be contained in a casing of the receiver device while placing the other antenna outside of the casing. The base band frequency of the keyless entry system may be set to a frequency lower than that of the tire pressure monitoring system to thereby realize higher sensitivity in the keyless entry system and higher response speed in the tire pressure monitoring system.

According to the present invention, two input signals having different frequencies are handled in a single receiver device. Accordingly, the two input signals are cost-effectively handled by a simple device which is easily mounted on a vehicle. Other objects and features of the present invention will become more readily apparent from a better understanding of the preferred embodiment described below with reference to the following drawings.

### BRIEF DESCRIPTION OF THE DRAWINGS

FIG. 1 is a block diagram showing an entire structure of an on-board system including the keyless entry system and the tire pressure monitoring system;

FIG. 2 is a block diagram showing a receiver according to the present invention;

FIG. 3 is a flowchart showing a process of controlling the receiver; and

FIG. 4 is a block diagram showing a conventional receiver used in a keyless entry system.

### DETAILED DESCRIPTION OF THE PREFERRED EMBODIMENT

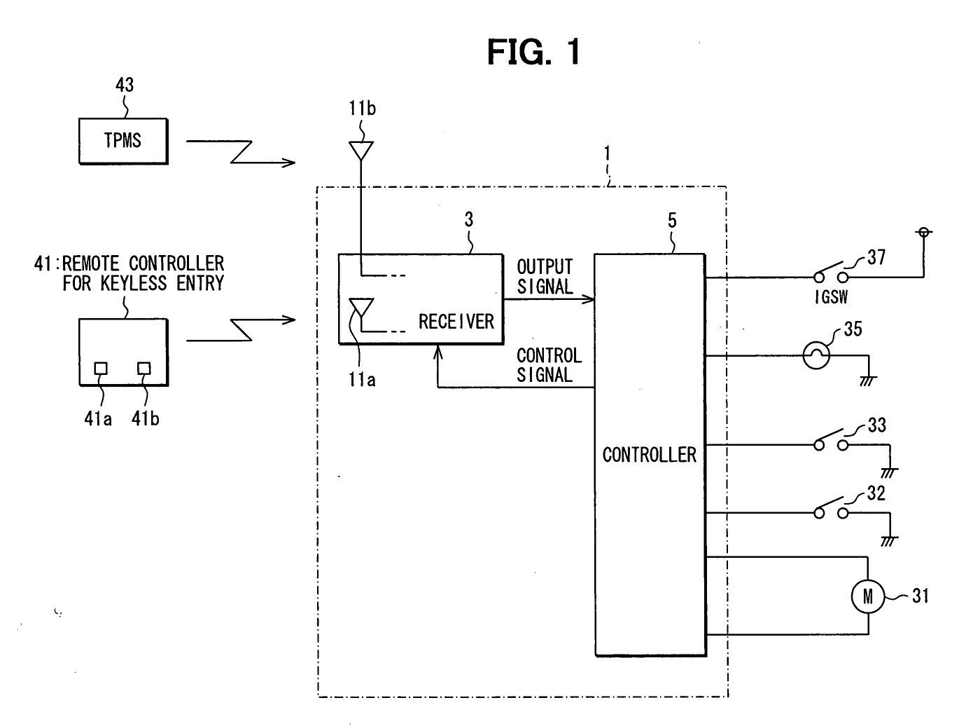

A preferred embodiment according to the present invention will be described with reference to FIGS. 1-3. The system shown in FIG. 1 is an on-board system that includes a keyless entry system and a tire pressure monitoring system. The system has a single receiver 3 that is able to handle two wireless signals having respectively different frequencies and a controller 5 for controlling operation of the system. The receiver 3 and the controller 5 form a receiver device 1. A first input signal sent from a remote controller 41 for the keyless entry system is received by a first antenna 11a contained in the receiver 3, and a second input signal sent from a tire pressure detecting switch 43 in a tire pressure monitoring system (referred to TPMS) is received by a second antenna 11b positioned outside of the receiver 3.

The controller 5 is a known microcomputer including CPU, ROM and RAM. Following devices and switches are connected to the controller 5: a door-lock motor 31 for locking and unlocking a door-lock; a door-lock switch 32 for detecting whether a door is locked or unlocked; a detector switch 33 for detecting whether a door is open or closed; a warning lamp 35 for notifying a driver that a tire pressure decreased; and an ignition switch 37. The door-lock motor 31, the door-lock switch 32 and the detector switch 33 are provided for each door. The warning lamp 35 is positioned in an instrument panel, for example, and is provided for each tire.

Though the keyless entry system and the TPMS are known systems, these systems will be briefly described below. In the keyless entry system, when either a lock-button 41a or an unlock-button 41b of the remote controller 41 is pushed, a wireless input signal (the first input signal) is transmitted and received by the first antenna 11a of the receiver 3. The first input signal is composed of a command signal (lock or unlock) and a vehicle identification signal (a signal for identifying a vehicle). The first input signal is fed to the receiver 3, and the receiver 3 determines whether the vehicle identification signal corresponds to that of the own vehicle. If the vehicle identification signal is correct, the door is operated according to the command signal. That is, when the lock-button 41a is pushed, all doors are locked, and when the unlock-button 41b is pushed, all doors are unlocked.

In the TPMS, the tire pressure detecting switch 43 installed in each tire wirelessly transmits a signal indicating a tire pressure (the second input signal). The second input signal includes another signal identifying a tire from which the pressure signal is transmitted. The second input signal is periodically transmitted from each tire in timing not overlapping one another. The second input signal is fed to the receiver 3 that detects a tire pressure in each tire, and the warning lamp 35 is lit when the tire pressure becomes lower than a predetermined level.

The first input signal and the second input signal are signals modulated with a same modulation method, but frequencies are different from each other to avoid confusion. In addition, frequencies of base bands (i.e., communication bit rate) in the first and the second input signals are different from each other. In the keyless entry system, sensitivity (a communicable distance) is more important than response speed, while the response speed is more important in the TPMS. Therefore, the communication bit rate of the TPMS is set higher than that of the keyless entry system. The base band frequency of the TPMS is 2.5 KHz, and that of the keyless entry system is 0.5 KHz in this particular embodiment.

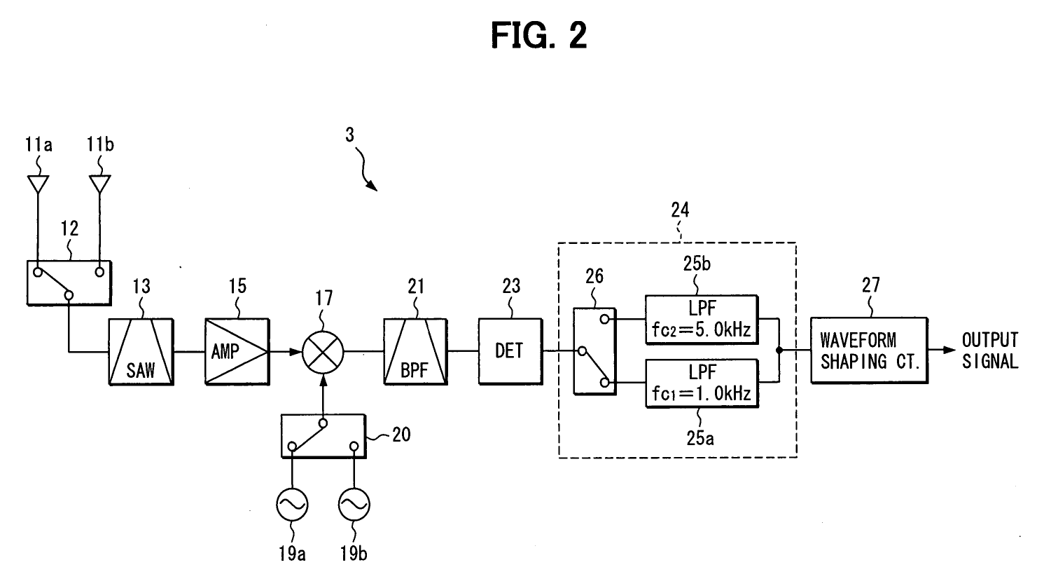

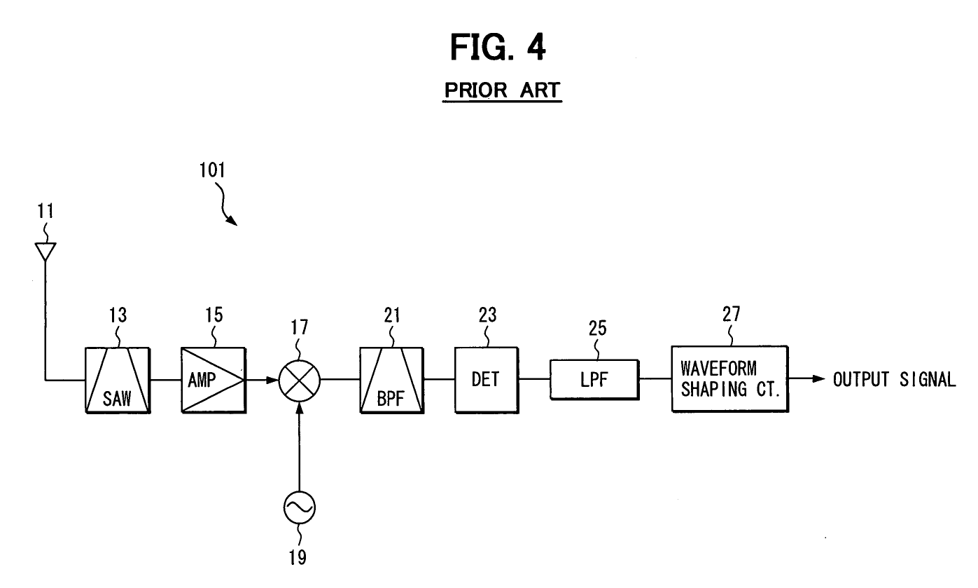

The receiver 3 of the present invention will be described with reference to FIG. 2. The receiver 3 is a superheterodyne-type which is the same as the conventional receiver 101 shown in FIG. 4. Components which are the same as those of the conventional receiver have the same reference numbers, and explanation of the same components is not repeated here.

As shown in FIG. 2, the receiver 3 has two antennas, the first antenna 11a and the second antenna 11b. The first antenna 11a receives the first input signal for the keyless entry system, and the second antenna 11b receives the second input signal for the TPMS. An input switch 12 selects either the first input signal or the second input signal, and the selected signal is fed to the SAW filter 13. The first antenna 11a is positioned inside a casing of the receiver 3. It is positioned along an inner wall of the casing or on a circuit board constituting the receiver device 1, for example. The position and direction of the first antenna 11a is so selected that the first input signal is effectively received. The second antenna 11b is placed at an outside of the casing of the receiver 3 where the second input signal is effectively received.

A first oscillator 19a generating a first local frequency signal (having a frequency fa) and a second oscillator 19b generating a second local frequency signal (having a frequency fb) are provided to supply local frequency signals to the mixer 17. An oscillator switch 20 selects either the first local frequency signal or the second local frequency signal, and the selected local frequency signal is fed to the mixer 17. When the first input signal from the keyless entry system is selected, the first local frequency signal is mixed with the first input signal. When the second input signal from the TPMS is selected, the second local frequency signal is mixed with the second input signal.

Assuming that the frequency of the first input signal is FA and the frequency of the second input signal is FB, the frequency fa of the first local frequency signal and the frequency fb of the second local frequency signal are set to satisfy the following formula: (FA−fa)=(FB−fb)=Fi, where Fi is the frequency of the intermediate frequency signal. In other words, the same intermediate frequency signal is obtained from the mixer 17 regardless of the selected input signal.

A filter device 24, composed of a filter switch 26, a first low pass filter 25a and a second low pass filter 25b, is used in this embodiment in place of the low pass filter 25 used in the conventional receiver 101 shown in FIG. 4. The first low pass filter 25a has a cutoff frequency fc1 which is set to two times of the base band frequency of the first input signal (i.e., fc1=2×0.5 KHz). The second low pass filter 25b has another cutoff frequency fc2 which is set to two times of the base band frequency of the second input signal (i.e., fc2=2×2.5 KHz). The filter switch 26 selects the first low pass filter 25a when the first input signal is fed to the receiver 3 and the second low pass filter 25b when the second input signal is fed.

The first low pass filter 25a eliminates noise frequencies higher than the cutoff frequency fc1 included in the base band frequency of the first input signal. The second low pass filter 25b eliminates noise frequencies higher than the cutoff frequency fc2 included in the base band frequency of the second input signal. The base band signals are fed from the filter device 24 to the waveform shaping circuit 27. Output signals shaped in rectangular waveforms are fed from the waveform shaping circuit 27 to the controller 5.

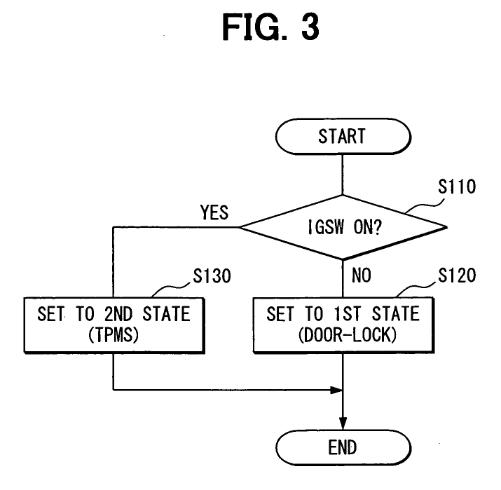

A process of controlling the receiver 3, which is performed by the controller 5, will be explained with reference to FIG. 3. Upon starting the process, at step S110, whether the ignition switch 37 is turned on is checked. If the ignition switch is not turned on, the process proceeds to step S120 where the receiver 3 is brought to a first state. If the ignition switch 37 is turned on, the process proceeds to step S130 where the receiver 3 is brought to a second state. Then, the process comes to the end.

In the first state: the first antenna 11a is selected by the input switch 12 to receive the first input signal from the keyless entry system; the first oscillator 19a is selected by the oscillator switch 20 to supply the first local frequency signal (fa) to the mixer 17; and the first low pass filter 25a is selected by the filter switch 26. This means that, during the period in which the ignition switch is turned off, the first input signal from the keyless entry system is fed, the base band signal of the first input signal is abstracted from the intermediate frequency signal Fi, and the output signal (data signal) is obtained by eliminating noises and shaping the base band signal. The digital signal including the vehicle identification signal and the command signal for the keyless entry system is obtained from the output signal in the controller 5. According to the command signal, the door-lock motor 31 is driven to lock or unlock the door-lock.

In the second state: the second antenna 11b is selected by the input switch 12 to receive the second input signal from the TPMS; the second oscillator 19b is selected by the oscillator switch 20 to supply the second local frequency signal (fb) to the mixer 17; and the second low pass filter 25b is selected by the filter switch 26. This means that, during the period in which the ignition switch is turned on, the second input signal from the TPMS is fed, the base band signal of the second input signal is abstracted from the intermediate frequency signal Fi, and the output signal (data signal) is obtained by eliminating noises and shaping the base band signal. The digital signal including the tire pressure data for each tire is obtained from the output signal in the controller 5. According to this digital signal, the tire pressure in each tire is detected and the warning lamp 35 is lit.

Advantages attained in the present invention will be summarized below. Tow input signals are switched by the input switch 12, two local frequency signals to be fed to the mixer 17 are switched by the oscillator switch 20 to obtain the same intermediate frequency signal (Fi) for both input signals, and two low pass filters having different cutoff frequencies (fc1, fc2) are switched by the filter switch 26. Therefore, wireless input signals, having frequencies different from each other, for both the keyless entry system and the TPMS can be handled by a single receiver 3.

The base band frequency (the communication bit rate) of the keyless entry system is set to a frequency (0.5 KHz) which is lower than that of the TPMS (2.5 KHz). Therefore, the keyless entry system has a higher sensitivity (a longer communicable distance) than the TPMS, and the TPMS has a higher response speed than the keyless entry system. The first antenna 11a is contained in the casing of the receiver 3 while the second antenna 11b is positioned outside of the casing. Accordingly, a process of mounting the first antenna on the vehicle is eliminated. The second antenna may be contained in the casing while positioning the first antenna outside of the casing, if better efficiency of the antennas is obtained in such positioning.

The present invention is not limited to the embodiment described above, but it may be variously modified. For example, though two oscillators 19a, 19b are used in the embodiment, it is possible to use one oscillator in which the oscillating frequency is changeable according to a signal supplied from the outside. Similarly, two low pass filters 25a, 25b used in the embodiment may be replaced with one low pass filter in which cutoff frequency is changeable according to a signal fed from the outside. Though the present invention is applied to an on-board device having the keyless entry system and the TPMS, the keyless entry system may be replaced with a power sunroof system, a power window system or the like.

While the present invention has been shown and described with reference to the foregoing preferred embodiment, it will be apparent to those skilled in the art that changes in form and detail may be made therein without departing from the scope of the invention as defined in the appended claims.

What is claimed is:

1. A receiver device mounted on an automotive vehicle, comprising:
a first antenna for receiving a first input signal wirelessly transmitted from a remote controller for locking or unlocking a door-lock of the automotive vehicle;
a second antenna for receiving a second input signal wirelessly transmitted from a tire pressure monitoring system mounted on the automotive vehicle for monitoring a tire pressure;
an input switch for selecting either the first input signal or the second input signal;
a first oscillator for generating a first local frequency signal;
a second oscillator for generating a second local frequency signal;
a mixer for mixing an input signal selected by the input switch with either the first local frequency signal or the second local frequency signal and for outputting an intermediate frequency signal; and
a controller for controlling the receiver device to bring it to a first state, the first state being a state in which the first input signal is selected by the input switch, the first local frequency signal is generated by the first oscillator, and the first input signal and the first local frequency signal are mixed in the mixer to output the intermediate frequency signal, and the second state being a state in which the second input signal is selected by the input switch, the second local frequency signal is generated by the second oscillator, and the second input signal and the second local frequency signal are mixed in the mixer to output the intermediate frequency signal; and
a demodulator for abstracting base band signals included in the first input signal and the second input signal from the intermediate frequency signal.

2. The receiver device as in claim 1, wherein:
the controller brings the receiver device to the first state when an ignition switch of the automotive vehicle is turned off, and to the second state when the ignition switch is turned on.

3. The receiver device as in claim 1, further including a low pass filter for cutting off noises included in the base band signals, and a waveform shaping circuit for outputting a shaped output, wherein:
a cutoff frequency of the low pass filter is set to a first cutoff frequency in the first state and to a second cutoff frequency in the second state.

4. The receiver device as in claim 1, wherein:
the first antenna and the second antenna are positioned at different positions from each other.

5. The receiver device as in claim 4, wherein:
either the first antenna or the second antenna is positioned in a casing of the receiver device, and the other antenna is positioned outside of the casing.

6. The receiver device as in claim 1, wherein:
a frequency of the base band signal in the first input signal is set to a frequency lower than a frequency of the base band signal in the second input signal.
